(19) United States
(12) Patent Application Publication
(10) Pub. No.: US 2026/0106329 A1
(43) Pub. Date: Apr. 16, 2026

(54) BATTERY APPARATUS AND METHOD FOR MANUFACTURING BATTERY APPARATUS

(71) Applicant: SK ON CO., LTD., Seoul (KR)

(72) Inventors: Soo Hwan JO, Daejeon (KR); Jeong Joo LEE, Daejeon (KR)

(21) Appl. No.: 19/287,830

(22) Filed: Aug. 1, 2025

(30) Foreign Application Priority Data
Oct. 14, 2024 (KR) 10-2024-0139340

(51) Int. Cl. H01M 50/503; H01M 50/178; H01M 50/514

(52) U.S. Cl. CPC H01M 50/503; H01M 50/178; H01M 50/514

(57) ABSTRACT

The present disclosure relates to a battery apparatus, which may include: a plurality of battery cells respectively including a plurality of electrode leads; a busbar member connected to the plurality of electrode leads; and a busbar frame supporting the busbar member, and the busbar frame may include a support surface facing the busbar member, and the support surface may include at least one cooling groove.

### CROSS-REFERENCE TO RELATED APPLICATION(S)

This patent document claims the priority and benefits of Korean Patent Application No. 10-2024-0139340 filed on Oct. 14, 2024, the disclosure of which is incorporated herein by reference in its entirety.

### TECHNICAL FIELD

The present disclosure relates to a battery apparatus and a method for manufacturing a battery apparatus.

### BACKGROUND

Batteries are widely used in small electronic devices such as mobile phones and laptop computers as well as medium and large mechanical devices such as electric vehicles (EVs) and energy storage devices, and have the advantage of being rechargeable and reusable.

An electrode assembly including a cathode plate and an anode plate may be stored in a case selected according to the purpose of use, such as a pouch type, square type, or cylindrical type, and an electrolyte may be injected to manufacture a battery cell.

A battery apparatus may be configured by connecting a plurality of battery cells with a busbar. The battery apparatus may be, for example, a battery module and/or a battery pack.

A region in which the battery cells and the busbar are connected may generate heat. When the heat generation continues and a temperature of the battery apparatus rises to an appropriate level or higher, the performance of the battery apparatus may be degraded. Additionally, the electrical stability and safety of use of the battery apparatus may be degraded.

### SUMMARY

According to an aspect of the present disclosure, a battery apparatus having improved performance and suppression of excessive heat generation and a method for manufacturing the battery apparatus are provided.

Additionally, according to an aspect of the present disclosure, a battery apparatus having improved electrical stability and safety in use and a method for manufacturing the battery apparatus are provided.

Additionally, the present disclosure may be widely applied to devices within green technology fields such as solar power generation and wind power generation.

Additionally, the present disclosure may be applied to eco-friendly devices such as eco-friendly electric vehicles and hybrid vehicles for ameliorating the effects of climate change by suppressing air pollution and greenhouse gas emissions.

A battery apparatus according to an embodiment of the present disclosure may include: a plurality of battery cells respectively including a plurality of electrode leads; a busbar member connected to the plurality of electrode leads; and a busbar frame supporting the busbar member, wherein the busbar frame may include a support surface facing the busbar member, and the support surface includes at least one cooling groove.

In an embodiment, the plurality of battery cells may include: an external material accommodating an electrode assembly; and the plurality of electrode leads connected to the electrode assembly and drawn out to the outside of the external material, and the support surface and the at least one cooling groove may not face the external material.

In an embodiment, the at least one cooling groove may be disposed above the plurality of electrode leads in a height direction of the battery cell, in a width direction cross-section of the battery cell.

In an embodiment, the battery apparatus may further include an insulating member disposed in the at least one cooling groove.

In an embodiment, the at least one cooling groove may have an outer line having a polygonal shape in a thickness direction cross-section of the battery cell.

In an embodiment, the at least one cooling groove may have an outer line including a curve in a thickness direction cross-section of the battery cell.

In an embodiment, the busbar frame may further include at least one exhaust groove connected to at least one cooling groove and extending toward a region not facing the busbar member.

In an embodiment, the at least one exhaust groove may include: a first exhaust groove connected to one side of the at least one cooling groove and extending in a direction, parallel to a thickness direction of the battery cell; and a second exhaust groove connected to the other side of the at least one cooling groove and extending in a direction, intersecting the first exhaust groove.

In an embodiment, at least one of the first exhaust groove and the second exhaust groove may extend to an edge of the busbar frame.

In an embodiment, the busbar member may include: a plurality of connection busbar members disposed on one side and the other side of the battery cell, and connecting a pair of electrode leads adjacent to each other; a first outermost busbar member disposed on one side or the other side of the battery cell, and connected to a first outermost battery cell disposed on an outermost side of one side, among the plurality of battery cells; and a second outermost busbar member disposed on one side or the other side of the battery cell, and connected to a second outermost battery cell disposed on an outermost side of the other side, among the plurality of battery cells.

In an embodiment, the at least one cooling groove may include a plurality of cooling grooves, and the plurality of cooling grooves may face the first outermost busbar member and the second outermost busbar member.

In an embodiment, in a height direction of the battery cell, a height of the first outermost busbar member and the second outermost busbar member may be higher than a height of at least one connection busbar member, among the plurality of connection busbar members.

In an embodiment, the at least one cooling groove may include a region exceeding a height of the at least one connection busbar member in a height direction of the battery cell.

The at least one cooling groove may include a plurality of cooling grooves, and the plurality of cooling grooves may face the plurality of connection busbar members.

Meanwhile, in another aspect, the present disclosure provides a method for manufacturing a battery apparatus comprising a plurality of battery cells respectively including a plurality of electrode leads, a busbar member connected to the plurality of electrode leads and a busbar frame supporting the busbar member.

A method for manufacturing a battery apparatus may further include: a preparatory operation of preparing the busbar frame having at least one cooling groove formed on a support surface supporting the busbar member; and an electrode lead connection operation of connecting the plurality of electrode leads to the busbar member.

According to an aspect of the present disclosure, a battery apparatus having improved performance and suppression of excessive heat generation and a method for manufacturing the battery apparatus may be provided.

Additionally, according to an aspect of the present disclosure, a battery apparatus having improved electrical stability and safety in use and a method for manufacturing the battery apparatus may be provided.

Additionally, the present disclosure may be widely applied to devices within green technology fields such as solar power generation and wind power generation.

Additionally, the present disclosure may be applied to eco-friendly devices such as eco-friendly electric vehicles and hybrid vehicles for ameliorating the effects of climate change by suppressing air pollution and greenhouse gas emissions.

### BRIEF DESCRIPTION OF DRAWINGS

Certain aspects, features, and advantages of the present disclosure are illustrated by the following detailed description with reference to the accompanying drawings.

FIG. 1 is a schematic perspective view of a battery apparatus according to an embodiment of the present disclosure.

FIG. 2 is a schematic view of a cross-section taken along line I-I′ of FIG. 1.

FIG. 3 is a schematic view of a cross-section taken along line II-II′ of FIG. 2.

FIG. 4 is a schematic view of a busbar frame, a busbar member, and an electrode lead according to an embodiment of the present disclosure.

FIG. 5 is a schematic view of a cross-section taken along line II-II′ of a battery apparatus according to another embodiment of the present disclosure.

FIG. 6 is a schematic view of a busbar frame, a busbar member, and an electrode lead according to another embodiment of the present disclosure.

FIG. 7 is a schematic view of a busbar frame, a busbar member, and an electrode lead according to another embodiment of the present disclosure.

FIG. 8 is a schematic view of a busbar frame, a busbar member, and an electrode lead according to another embodiment of the present disclosure.

FIG. 9 is a schematic exploded perspective view of a battery apparatus according to another embodiment of the present disclosure.

FIG. 10 is a schematic illustration of a method for manufacturing a battery apparatus according to an embodiment of the present disclosure.

### DETAILED DESCRIPTION

In order to help understand the description of the embodiment of the present disclosure, elements described with the same symbol in the attached drawings are the same elements. Some components in the attached drawings are exaggerated, omitted, or schematically illustrated, and the size of each component does not completely reflect the actual size.

Additionally, in order to clarify the gist of the present disclosure, descriptions of elements and techniques well known by conventional techniques are omitted, and the present disclosure will be described in detail below with reference to the attached drawings.

Hereinafter, an X-axis illustrated in the drawings is a thickness direction of a battery cell 110, a Y-axis is a width direction of the battery cell 110, and a Z-axis is a height direction of the battery cell 110. However, these are directions arbitrarily set for the convenience of understanding, and the directions may be changed.

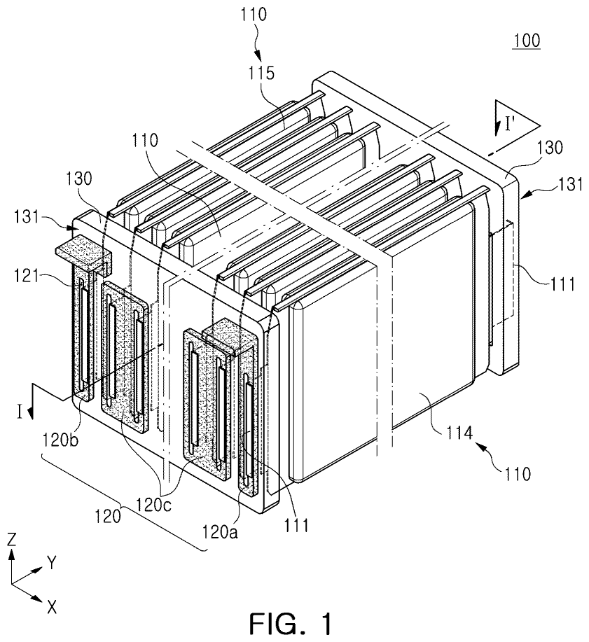

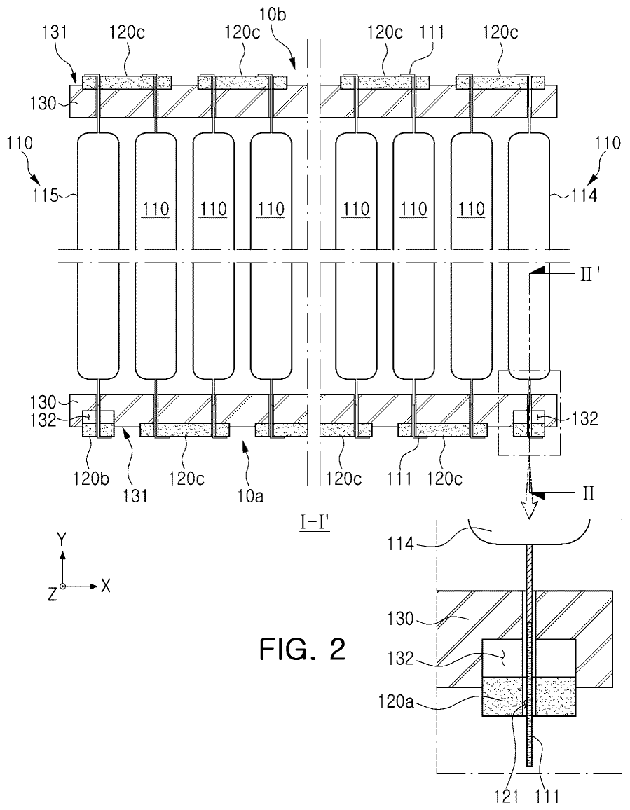

FIG. 1 is a schematic perspective view of a battery apparatus 100 according to an embodiment of the present disclosure, and FIG. 2 schematically illustrates a cross-section along line I-I′ of FIG. 1. In FIG. 2, a battery cell 110 and an electrode lead 111 are not illustrated in the cross-section.

As shown in FIGS. 1 and 2, the battery apparatus 100 according to an embodiment of the present disclosure may include a plurality of battery cells 110 respectively including a plurality of electrode leads 111, a busbar member 120 connected to the plurality of electrode leads 111, and a busbar frame 130 supporting the busbar member 120. The busbar frame 130 may include a support surface 131 facing the busbar member 120, and the support surface 131 may include at least one cooling groove 132 for cooling the busbar member 120.

A plurality of battery cells 110 may be stacked or arranged in a thickness direction (X-direction) of the battery cell 110.

The battery cell 110 may be a secondary battery and may be a lithium ion battery cell 110. Additionally, the battery cell 110 may be a pouch-type battery cell 110. The battery cell 110 may have an electrode assembly including a cathode plate, an anode electrode plate, and a separator inside an external material 112, and an electrolyte. The external material 112 may be in the form of a film or a sheet, and may be sealed when the electrode assembly and the electrolyte are accommodated therein.

The battery cell 110 may be a bidirectional battery cell 110 or a unidirectional battery cell 110 depending on a position at which the electrode lead 111 is drawn out from the external material 112.

Hereinafter, a bidirectional battery cell 110 in which one electrode lead 111 is drawn out from one side of the external material 112 and another electrode lead 111 is drawn out from the other side of the external material 112 will be described as an example. Here, one electrode lead 111 may be connected to a cathode plate accommodated inside the external material 112, and another electrode lead 111 may be connected to an anode plate accommodated inside the external material 112.

However, the type of the battery cell 110 is not necessarily limited by the present disclosure, and the battery cell 110 may be transformed into a form other than a secondary battery, a lithium ion battery cell 110, and a pouch-type battery cell 110.

The busbar frame 130 may support the busbar member 120. The busbar frame 130 may be provided with a material having electrical insulation. For example, the busbar frame 130 may be an injection-molded product. In some cases, the busbar frame 130 may be double-injected or insert-injected. Double-injected may be one of the injection molding methods for injecting a plurality of different types of resins. However, the molding method of the busbar frame 130 is not necessarily limited by the present disclosure.

The busbar member 120 may include a material having electrical conductivity. The busbar member 120 may be provided in plural. One busbar member 120 may be connected to one electrode lead 111 connected to a cathode plate of the battery cell 110, and another busbar member 120 may be connected to another electrode lead 111 connected to an anode plate of the battery cell 110. With this principle, a plurality of busbar members 120 may be electrically connected to the battery cell 110.

The busbar member 120 may include a first slot 121 through which the electrode lead 111 passes. The first slot 121 may be provided as a hole, slit, or the like, which passes through the busbar member 120. The electrode lead 111 may be bent in a direction oriented toward the busbar member 120 by passing through the first slot 121, and may then be welded to the busbar member 120. A direction in which the electrode lead 111 is bent is not necessarily limited by the present disclosure.

The busbar member 120 may be in contact with the support surface 131 of the busbar frame 130. Additionally, when a plurality of busbar members 120 are provided, a plurality of busbar members 120 may be in contact with the support surface 131 of the busbar frame 130. The busbar member 120 may be in contact with the support surface 131 and then fixed to the busbar frame 130.

The support surface 131 may not face the battery cell 110 or a region in which the electrode assembly is accommodated in the battery cell 110.

In an embodiment, the support surface 131 may be provided with at least one cooling groove 132. The cooling groove 132 may be a groove formed concavely in a direction oriented toward the center of gravity of the busbar frame 130 on the support surface 131, the centroid of the busbar frame 130, and a region in which the electrode assembly is accommodated in the battery cell 110.

The centroid of the busbar frame 130 may be a centroid of a rectangle when an outer line of the busbar frame 130 is the rectangle in a plane (X-Z plane), perpendicular to or intersecting a thickness direction of the battery cell 110.

However, since the busbar frame 130 is a polyhedron having a certain width in a width direction (Y-direction) of the battery cell 110, the centroid of the busbar frame 130 may be present in a position moved by a certain distance from the plane (X-Z plane) or the support surface 131 in a +Y-direction or in a direction oriented toward the battery cell 110 or in a direction away from the support surface 131.

The busbar frame 130 may be spaced apart from the busbar member 120 in a region in which the cooling groove 132 is disposed on the support surface 131. The cooling groove 132 may separate the busbar frame 130 from the busbar member 120, and may allow air to flow. Accordingly, the cooling groove 132 may cool the busbar member 120. Accordingly, excessive heat generation of the battery apparatus 100 may be suppressed. This may contribute to improving the electrical performance of the battery apparatus 100, and improving the electrical stability of the battery apparatus 100.

Additionally, the busbar frame 130 may be prevented from being carbonized or melted due to excessive heat generation of the busbar member 120.

In an embodiment, the busbar member 120 may include a plurality of connection busbar members 120c respectively disposed on one side 10a and the other side 10b of the battery cell 110 and connecting a pair of electrode leads 111 adjacent to each other, a first outermost busbar member 120a disposed on one side 10a or the other side 10b of the battery cell 110 and connected to a first outermost battery cell 114 disposed on an outermost side of one side, among the plurality of battery cells 110, and a second outermost busbar member 120b disposed on one side 10a or the other side 10b of the battery cell 110 and connected to a second outermost battery cell 115 disposed on an outermost side of the other side, among the plurality of battery cells 110.

In an embodiment, the busbar frame 130 may be provided in plural. One busbar frame 130 among the plurality of busbar frames 130 may be disposed on one side 10a of the battery cell 110, and another busbar frame 130 may be disposed on the other side 10b of the battery cell 110. The support surface 131 of each of the plurality of busbar frames 130 may not face the battery cell 110 or a region in which an electrode assembly is accommodated in the battery cell 110. Alternatively, the support surface 131 of each of the plurality of busbar frames 130 may not face a region in which the electrode assembly is accommodated in the external material 112. Additionally, the support surface 131 of each of the plurality of busbar frames 130 may face, in an opposite direction, the battery cell 110 or a region in which the electrode assembly is accommodated in the battery cell 110. Here, facing in the opposite direction may mean that in a thickness direction cross-section (Y-Z plane) of the busbar frame 130, some component (for example, an inner surface 131a of the busbar frame) is disposed between the support surface 131 of each of the plurality of busbar frames 130 and a region in which the electrode assembly is accommodated in the battery cell 110, and the support surface 131 of each of the plurality of busbar frames 130 and the region in which the electrode assembly is accommodated in the battery cell 110 may not directly face each other.

That is, the support surface 131 of each of the plurality of busbar frames 130 may face the battery cell 110 or the region in which the electrode assembly is accommodated in the battery cell 110 with the inner surface 131a of each of the plurality of busbar frames 130 interposed therebetween. Additionally, in the thickness direction cross-section (Y-Z plane) of the busbar frame 130, the inner surface 131a of each of the plurality of busbar frames 130 may be disposed between the support surfaces 131 of the plurality of busbar frames 130 and an electrode assembly accommodation space 113.

A pair of electrode leads 111 adjacent to each other may be adjacent to each other in the thickness direction (X-direction) of the battery cell 110. The pair of electrode leads 111 may be adjacent to each other on one side 10a of the battery cell 110, and the pair of electrode leads 111 may also be adjacent to each other on the other side 10b of the battery cell 110. The pair of electrode leads 111 adjacent to each other on one side 10a of the battery cell 110 may be connected to each other by one busbar member 120, and the pair of electrode leads 111 adjacent to each other on the other side 10b of the battery cell 110 may be connected to each other by another busbar member 120.

With respect to one battery cell 110, one side 10a of the battery cell 110 may be a region from which one electrode lead 111 is drawn out, and the other side 10b of the battery cell 110 may be a region from which another electrode lead 111 is drawn out. In a bidirectional battery cell 110, one electrode lead 111 and another electrode lead 111 may not face each other. Additionally, a region in which an electrode assembly is accommodated may be disposed between one electrode lead 111 and another electrode lead 111 in a bidirectional battery cell 110.

In an embodiment, a plurality of battery cells 110 may be connected in series. Additionally, the electrode leads 111 of each of a pair of battery cells 110 adjacent to each other on one side 10a of the battery cell 110 may be connected by one connection busbar member 120c. Additionally, the electrode leads 111 of each of a pair of battery cells 110 adjacent to each other on the other side 10b of the battery cell 110 may be connected by another connection busbar member 120c.

In an embodiment, a plurality of electrode leads 111 connected to one connection busbar member 120c on one side 10a of the battery cell 110 may have electrically different polarities. For example, among the pair of battery cells 110 adjacent to each other on one side 10a of the battery cell 110, the electrode lead 111 of one battery cell 110 may be connected to the cathode plate, and the electrode lead 111 of another battery cell 110 may be connected to the anode plate. Additionally, in this case, among the pair of battery cells 110 adjacent to each other on the other side 10b of the battery cell 110, the electrode lead 111 of one battery cell 110 may be connected to the cathode plate, and the electrode lead 111 of another battery cell 110 may be connected to the anode plate.

In this case, in a pair of battery cells 110 in which the electrode leads 111 are connected by one connection busbar member 120c on one side 10a of the battery cell 110, respective electrode leads 111 may not be connected to each other by the connection busbar member 120c on the other side 10b of the battery cell 110.

In another embodiment, a plurality of electrode leads 111 connected to one connection busbar member 120c may have the same electrical polarity. For example, the electrode leads 111 of each of a pair of battery cells 110 adjacent to each other on one side 10a of the battery cell 110 may be connected to a cathode plate, and the electrode leads 111 connected to the cathode plate may be connected to one connection busbar member 120c.

Additionally, the electrode leads 111 of each of a pair of battery cells 110 adjacent to each other on the other side 10b of the battery cell 110 may be connected to an anode plate, and the electrode leads 111 connected to the anode plate may be connected to another connection busbar member 120c.

As described above, the plurality of battery cells 110 may be connected in parallel or in series, but a method of connecting the plurality of battery cells 110 is not necessarily limited by the present disclosure.

In an embodiment, the first outermost busbar member 120a and the second outermost busbar member 120b may be disposed on one side 10a of the battery cell 110. For example, the first outermost busbar member 120a may be connected to the cathode lead 111 connected to the cathode plate of the first outermost battery cell 114, and the second outermost busbar member 120b may be connected to the anode electrode lead 111 connected to the anode electrode plate of the second outermost battery cell 115. However, such connection relationships may be applied interchangeably.

Specifically, the plurality of battery cells 110 may include a first outermost battery cell 114 disposed on the outermost side (+X-direction) in a stacking direction of the battery cells 110 in a state in which the plurality of battery cells 110 are stacked, and a second outermost battery cell 115 disposed on an outermost side (−X-direction) in the stacking direction of the battery cells 110.

In the plurality of battery cells 110, the remaining busbar members 120 except for the first outermost busbar member 120a and the second outermost busbar member 120b may be connection busbar members 120c. The connection busbar member 120c may be connected to an electrode lead 111 not connected to the first outermost busbar member 120a and an electrode lead 111 not connected to the second outermost busbar member 120b.

In the first outermost battery cell 114, another electrode lead 111 not connected to the first outermost busbar member 120a may be connected to the connection busbar member 120c on the other side 10b of the battery cell 110. Additionally, one electrode lead 111 of another battery cell 110 adjacent to the first outermost busbar member 120a in the −X-direction may be connected to the connection busbar member 120c.

Another electrode lead 111 not connected to the second outermost busbar member 120b in the second outermost battery cell 115 may be connected to the connection busbar member 120c on the other side 10b of the battery cell 110. Additionally, one electrode lead 111 of another battery cell 110 adjacent to the second outermost busbar member 120b in the +X-direction may be connected to the connection busbar member 120c.

For example, one connection busbar member 120c may be provided with a pair of first slots 121. Electrode leads 111 of different battery cell 110 may be inserted into each first slot 121. Accordingly, a pair of adjacent battery cells 110 may be electrically connected to each other.

In the thickness direction cross-section (X-Y plane) of the battery cell 110, based on one battery cell 110, a plurality of electrode leads 111 may be connected to different busbar members 120. For example, in the first outermost battery cell 114, one electrode lead 111 may be connected to the first outermost busbar member 120a, and another electrode lead 111 may be connected to the connection busbar member 120c.

Additionally, based on another battery cell 110 adjacent to the first outermost busbar member 120a in the −X-direction, one electrode lead 111 may be connected to the connection busbar member 120c to which the electrode lead 111 of the first outermost battery cell 114 is connected, on the other side 10b of the battery cell 110, and another electrode lead 111 may be connected to another connection busbar member 120c on one side 10a of the battery cell 110. The plurality of battery cells 110 may be connected in series with such a principle.

In an embodiment, the at least one cooling groove 132 may include a plurality of cooling grooves 132. The plurality of cooling grooves 132 may face (face-to-face) the first outermost busbar member 120a and the second outermost busbar member 120b, respectively. Here, the term “facing (face-to-face)” means that in the thickness direction cross-section (Y-Z plane) of the busbar frame 120, no other components are disposed between the cooling groove 132 and the first outermost busbar member 120a or between the cooling groove 132 and the second outermost busbar member 120b, and at least one surface of the cooling groove 132 and the first outermost busbar member 120a directly faces each other. Additionally, at least one surface of the cooling groove 132 and the second outermost busbar member 120b directly faces each other.

In this case, a plurality of cooling grooves 132 may be provided on the support surface 131 of the busbar frame 130 supporting the first outermost busbar member 120a and the second outermost busbar member 120b. The plurality of cooling grooves 132 may be spaced apart from each other in the stacking direction (X-direction) of the battery cells 110.

Accordingly, the first outermost busbar member 120a and the second outermost busbar member 120b may be easily cooled. Therefore, the busbar member 120 may be cooled in a region in which heat generation is relatively high.

The cooling groove 132 may have a certain volume. An open region in the cooling groove 132 may face the first outermost busbar member 120a and the second outermost busbar member 120b. Air may flow in the cooling groove 132. Accordingly, air cooling of the first outermost busbar member 120a and the second outermost busbar member 120b may be performed.

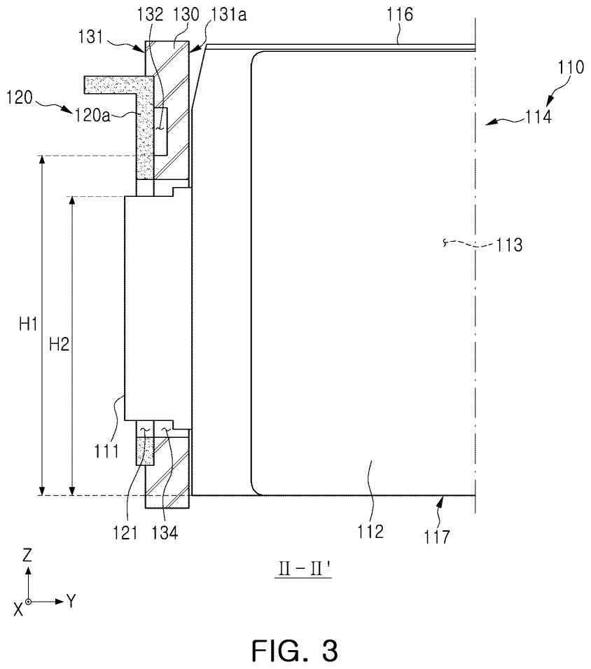

FIG. 3 is a schematic view of a cross-section taken along line II-II′ of FIG. 2. In FIG. 3, the battery cell 110 and the electrode lead 111 are not illustrated in the cross-section.

As shown in FIGS. 1 to 3, in an embodiment of the present disclosure, a plurality of battery cells 110 may include an external material 112 accommodating an electrode assembly, and a plurality of electrode leads 111 connected to the electrode assembly and drawn out to the outside of the external material 112. Here, the support surface 131 of the busbar frame 130 and the at least one cooling groove 132 may not face the external material 112.

The external material 112 may accommodate an electrode assembly therein, and a region in which the electrode assembly is accommodated in the external material 112 may be an electrode assembly accommodation space 113. The electrode assembly accommodation space may be sealed by sealing the external material 112. The external material 112 may be sealed in a region in which the electrode lead 111 is drawn out, and a side sealing portion 116.

The external material 112 does not have a sealed region, and a region in which the external material 112 is folded or a region including the folding line of the external material 112 may be a bottom surface 117 of the external material 112. The bottom surface of the external material 112 and the side sealing portion 116 may face each other in an opposite direction in a height direction (Z-direction) of the battery cell 110.

Although only one electrode lead 111 of one battery cell 110 is illustrated in FIG. 3, one battery cell 110 may have a structure that is symmetrical to the left and right with the structure illustrated in FIG. 3.

The busbar frame 130 may include a support surface 131 that does not face the external material 112 and an inner surface 131a facing the support surface 131 and facing the external material 112. The inner surface 131a may not face the busbar member 120. The cooling groove 132 may have a certain depth in a thickness direction of the busbar frame 130. The cooling groove 132 may not be connected to the inner surface 131a. Accordingly, the busbar member 120 may be cooled while preventing the rigidity or strength of the busbar frame 130 from being reduced.

For example, the support surface 131 of the busbar frame 130 and the at least one cooling groove 132 may not directly face the external material 112 or the electrode assembly accommodation space 113, which is a space in which the electrode assembly is accommodated in the external material 112, in the Y-direction, in the thickness direction cross-section (Y-Z plane) of the busbar frame 130. In this case, the inner surface 131a of the busbar frame 130 may be disposed between the support surface 131 of the busbar frame 130 and the electrode assembly accommodation space 113 and between the at least one cooling groove 132 and the electrode assembly accommodation space 113.

Additionally, in the thickness direction cross-section (Y-Z plane) of the busbar frame 130, the support surface 131 of the busbar frame 130 and the inner surface 131a of the busbar frame 130 may be surfaces facing each other. In this case, a material forming the busbar frame 130 may be filled between the support surface 131 of the busbar frame 130 and the inner surface 131a of the busbar frame 130.

The cooling groove 132 may be formed by removing a portion of the material forming the busbar frame 130 in the thickness direction cross-section (Y-Z plane) of the busbar frame 130. For example, the cooling groove 132 may be formed by recessing at least a portion of the support surface 131 of the busbar frame 130 in a direction oriented toward the electrode assembly accommodation space 113. The cooling groove 132 may include a certain volume, and a fluid such as air may exist in the cooling groove 132. Alternatively, the cooling groove 132 may be filled with a material for insulation.

Additionally, the first outermost busbar member 120a may have an end bent and may extend. An end of the first outermost busbar member 120a may extend in a direction away from the external material 112. The second outermost busbar member 120b may also have the same shape as the first outermost busbar member 120a.

The first outermost busbar member 120a and the second outermost busbar member 120b may be utilized to electrically connect a plurality of battery apparatus 100 to each other. The first outermost busbar member 120a and the second outermost busbar member 120b may have different electrical polarities, and may be connected to another first outermost busbar member 120a and a second outermost busbar member 120b of another adjacent battery apparatus 100. Accordingly, expansion or modularization of a plurality of battery apparatuses 100 may be facilitated. However, the shapes of the first outermost busbar member 120a, the second outermost busbar member 120b and the connection busbar member 120c are not necessarily limited by the present disclosure.

The busbar frame 130 may include a second slot 134 through which the electrode lead 111 passes. The second slot 134 may face the first slot 121 formed in the busbar member 120. The electrode lead 111 may pass through the second slot 134 and may pass through the first slot 121 and may be bent on an outer surface of the busbar member 120 in the −Y-direction. An end of the electrode lead 111 may be in contact with the busbar member 120.

In an embodiment, at least one cooling groove 132 may be disposed above the plurality of electrode leads 111 in the height direction of the battery cell 110, in the width direction cross-section of the battery cell 110.

In the width direction cross-section (Y-Z plane) of the battery cell 110, a first height H1 of the cooling groove 132 may be higher than a second height H2 of the electrode lead 111. The first height H1 and the second height H2 may be heights from the bottom surface 117 of the battery cell 110. The first height H1 may be a height from the bottom surface 117 to a lowest point of the cooling groove 132 in a −Z-direction, in the width direction cross-section of the battery cell 110.

The second height H2 may be a height from the bottom surface 117 to a highest point of the electrode lead 111 in the +Z-direction, in the width direction cross-section of the battery cell 110.

Additionally, as an example, the second height H2 may exceed a height of the first slot 121 in the Z-axis direction and a height of the second slot 134 in the Z-axis direction. Accordingly, the cooling groove 132 may be provided without interference with the electrode lead 111.

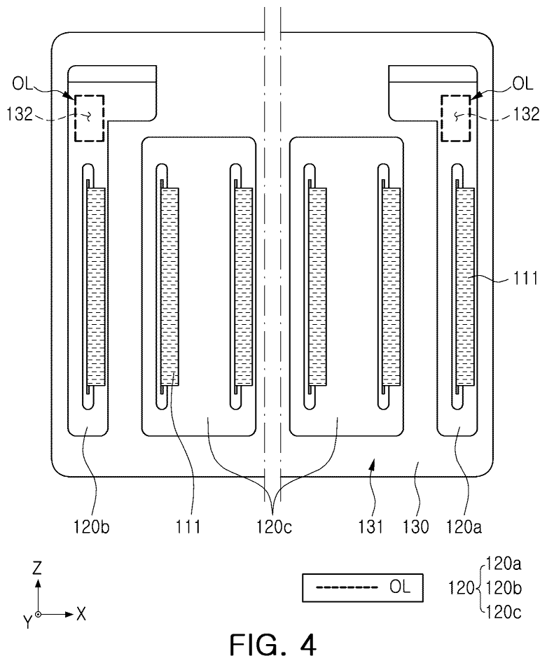

FIG. 4 schematically illustrates a busbar frame 130, a busbar member 120, and an electrode lead 111 according to an embodiment of the present disclosure.

As shown in FIG. 3 and FIG. 4, the first outermost busbar member 120a and the second outermost busbar member 120b may include a region in which a width of the battery cell 110 in the thickness direction (X-direction) is narrower than a width of the battery cell 110 of the connection busbar member 120c in the thickness direction (X-direction). A narrow region in the first outermost busbar member 120a and the second outermost busbar member 120b may have a relatively greater amount of heat generation than a wide region.

Accordingly, by making at least a portion of the cooling groove 132 disposed in the narrow region in the first outermost busbar member 120a and the second outermost busbar member 120b, the cooling efficiency of the first outermost busbar member 120a and the second outermost busbar member 120b may be increased.

In an embodiment, in at least one cooling groove 132, an outer line OL thereof may be a polygon in the thickness direction cross-section (X-Z plane) of the battery cell 110.

For example, in at least one cooling groove 132, an outer line OL thereof may be a square in the thickness direction cross-section (X-Z plane) of the battery cell 110. Accordingly, within the same area, an area of the cooling groove 132 may be secured to the maximum.

Additionally, in an embodiment, the cooling groove 132 may be provided in plural, and a plurality of cooling grooves 132 may be provided in each of the first outermost busbar member 120a and the second outermost busbar member 120b. In some cases, a plurality of cooling grooves 132 may be provided in the first outermost busbar member 120a, and a plurality of cooling grooves 132 may be provided in the second outermost busbar member 120b.

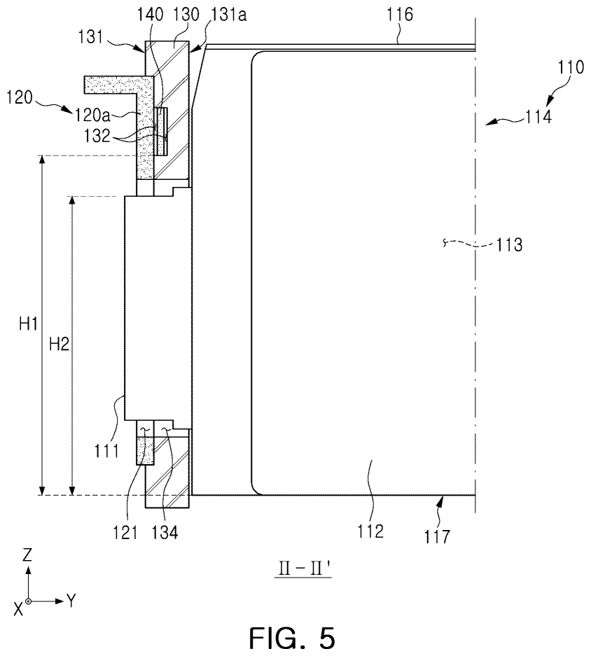

FIG. 5 is a schematic view of a cross-section taken along line II-II′ of a battery apparatus according to another embodiment of the present disclosure. Line II-II′ is illustrated in FIG. 2. However, the battery apparatus 100 illustrated in FIG. 5 may be a different embodiment from the battery apparatus 100 illustrated in FIG. 2. Additionally, the battery cell 110 and the electrode lead 111 are not illustrated in the cross-section in FIG. 5.

As shown in FIG. 5, the battery apparatus 100 according to another embodiment of the present disclosure may further include an insulating member 140 disposed in at least one cooling groove 132. The insulating member 140 may contribute to preventing thermal damage to the busbar frame 130 due to heat generation of the busbar member 120.

The insulating member 140 may include a material having relatively low thermal conductivity. For example, the insulating member 140 may include polystyrene foam (Styrofoam, EPS/XPS), polyurethane foam (Polyurethane Foam, PUR), fiberglass, and aerogel. Accordingly, it may be possible to prevent thermal damage to the busbar frame 130 while minimizing an increase in the weight of the battery apparatus 100.

In some cases, the insulating member 140 may be inserted into the cooling groove 132 and may fixed or adhered to the busbar frame 130. However, this is not necessarily limited by the present disclosure.

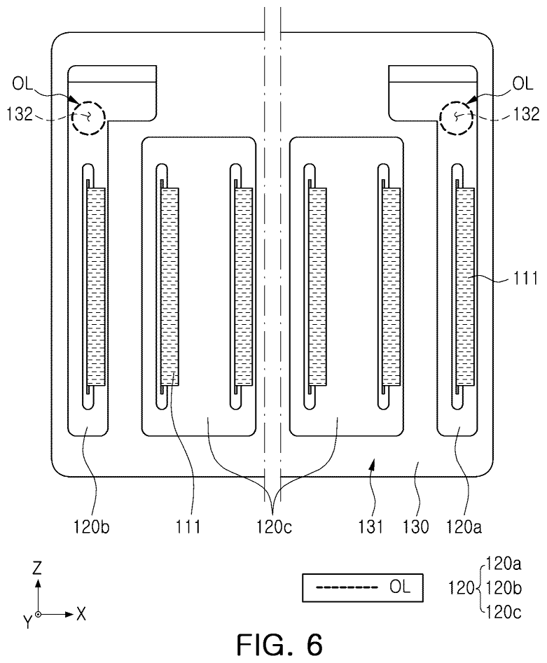

FIG. 6 is a schematic view of a busbar frame 130, a busbar member 120, and an electrode lead 111 according to another embodiment of the present disclosure.

As shown in FIG. 6, in another embodiment of the present disclosure, at least one cooling groove 132 may include an outer line OL having a curved shape in the thickness direction cross-section (X-Z plane) of the battery cell 110.

For example, the outer line OL of at least one cooling groove 132 may be circular. Additionally, for example, the shapes of the plurality of cooling grooves 132 may be identical to or different from each other. For example, the outer line OL of the cooling groove 132 facing the first outermost busbar member 120a may be circular, and the outer line OL of the cooling groove 132 facing the second outermost busbar member 120b may be polygonal.

Accordingly, the shape of the outer line OL of the cooling groove 132 may be appropriately applied by considering the heat generation amount of the busbar member 120, the specifications of the battery apparatus 100, and the like.

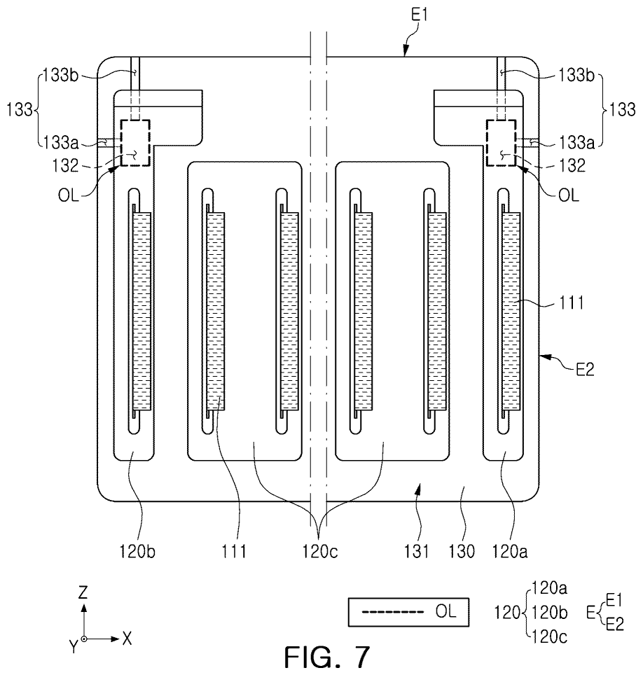

FIG. 7 is a schematic view of a busbar frame 130, a busbar member 120, and an electrode lead 111 according to another embodiment of the present disclosure.

As shown in FIG. 7, in another embodiment of the present disclosure, the busbar frame 130 may further include at least one exhaust groove 133 connected to at least one cooling groove 132 and extending toward a region that does not face the busbar member 120. For example, at least one exhaust groove 133 may include a region disposed between an edge of the busbar member 120 and an edge of the busbar frame 130 in the X-Z plane. Additionally, for example, at least one exhaust groove 133 may extend toward the edge of the busbar frame 130. The exhaust groove 133 may connect an edge of the busbar frame 130 and the cooling groove 132.

In an embodiment, at least one exhaust groove 133 may include a plurality of exhaust grooves 133. For example, one exhaust groove 133 among the plurality of exhaust grooves 133 may connect one edge of the cooling groove 132 and one edge of the busbar frame 130. Additionally, another exhaust groove 133 among the plurality of exhaust grooves 133 may connect the other edge of the cooling groove 132 and the other edge of the busbar frame 130. Additionally, for example, a plurality of exhaust grooves 133 may be connected to the cooling groove 132 facing the first outermost busbar member 120a. Additionally, the plurality of exhaust grooves 133 may be connected to the cooling groove 132 facing the second outermost busbar member 120b.

The exhaust groove 133 may be a passage through which air that completes a heat exchange with the busbar member 120 in the cooling groove 132 may escape to the outside of the busbar member 120 and the busbar frame 130. Additionally, on the contrary, the exhaust groove 133 may be a passage through which air having a relatively low temperature may be introduced into the exhaust groove 133. Accordingly, the cooling efficiency of the battery apparatus 100 may be increased.

In an embodiment, the at least one exhaust groove 133 may include a first exhaust groove 133a connected to one side of the at least one cooling groove 132 and extending in a direction, parallel to a thickness direction of the battery cell 110, and a second exhaust groove 133b connected to the other side of the at least one cooling groove 132 and extending in a direction, intersecting the first exhaust groove 133a.

For example, the first exhaust groove 133a and the second exhaust groove 133b may be connected to the cooling groove 132 facing the first outermost busbar member 120a, and the first exhaust groove 133a and the second exhaust groove 133b may be connected to the cooling groove 132 facing the second outermost busbar member 120b.

In some cases, at least one of the first exhaust groove 133a and the second exhaust groove 133b connected to the cooling groove 132 facing the first outermost busbar member 120a may be provided in plural. Similarly, at least one of the first exhaust groove 133a and the second exhaust groove 133b connected to the cooling groove 132 facing the second outermost busbar member 120b may be provided in plural. Accordingly, various air venting paths may be constructed.

Additionally, in an embodiment, at least one of the first exhaust groove 133a and the second exhaust groove 133b may be extended to an edge E of the busbar frame 130.

For example, the first exhaust groove 133a may extend parallel to the thickness direction (X-direction) of the battery cell 110 and may extend in a direction oriented toward a second edge E2 of the busbar frame 130. One side of the first exhaust groove 133a may be connected to the cooling groove 132, and the other side thereof may overlap the second edge E2.

Additionally, as an example, the second exhaust groove 133b may be formed to intersect or to be perpendicular to the first exhaust groove 133a. The second exhaust groove 133b may extend parallel to the height direction (Z-direction) of the battery cell 110, and may extend in a direction oriented toward a first edge E1 of the busbar frame 130. One side of the second exhaust groove 133b may be connected to the cooling groove 132, and the other side thereof may overlap the first edge E1.

Accordingly, air having completed heat exchange with the busbar member 120 may be discharged to the outside of the busbar frame 130. Accordingly, the cooling performance of the battery apparatus 100 may be improved. The improvement in the cooling performance of the battery apparatus 100 may contribute to the improvement of the electrical stability and safety in use of the battery apparatus 100.

Additionally, in an embodiment, in the height direction (Z-direction) of the battery cell 110, a height of the first outermost busbar member 120a and the second outermost busbar member 120b may be higher than a height of at least one connection busbar member 120c, among the plurality of connection busbar members 120c.

Here, at least one cooling groove 132 may include a region exceeding a height of at least one connection busbar member 120c in the height direction (Z-direction) of the battery cell 110. For example, at least one cooling groove 132 may include a region that extends beyond the height of the at least one connection busbar member 120c. For example, at least one cooling groove 132 may include a region having a height exceeding the height of the battery cell 110 of the connection busbar member 120c in the height direction (Z-direction). Accordingly, the cooling groove 132 may be disposed in a region having a relatively large amount of heat generation in the first outermost busbar member 120a and the second outermost busbar member 120b.

Additionally, in an embodiment, a bent region of the first outermost busbar member 120a and the second outermost busbar member 120b may be disposed in a region exceeding the height of the connection busbar member 120c in the Z-direction. In this case, at least a portion of the cooling groove 132 may be disposed in the bent region of the first outermost busbar member 120a and the second outermost busbar member 120b.

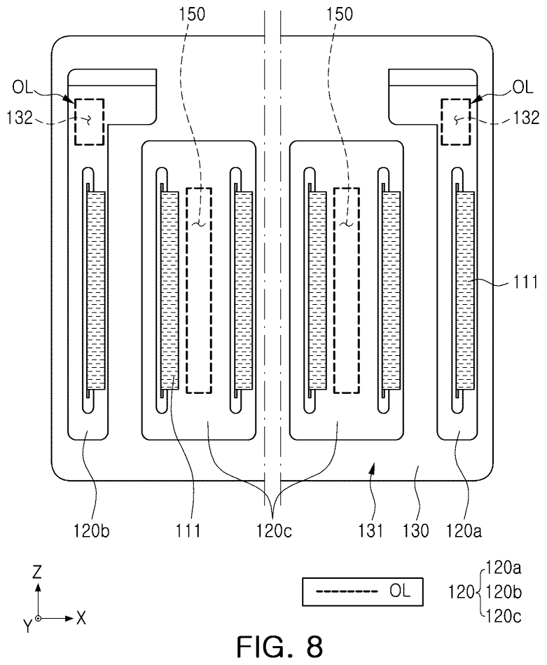

FIG. 8 schematically illustrates a busbar frame 130, a busbar member 120, and an electrode lead 111 according to another embodiment of the present disclosure.

As shown in FIG. 8, in another embodiment of the present disclosure, at least one cooling groove 132 may include a plurality of cooling grooves 132, and the plurality of cooling grooves 132 may face the plurality of connection busbar members 120c. For example, one cooling groove 132 may face one connection busbar member 120c. The number of cooling grooves 132 and the number of connection busbar members 120c may be equal to each other.

At least one of the plurality of cooling grooves 132 may be a connection busbar member cooling groove 150 facing the connection busbar member 120c. In an embodiment, the connection busbar member cooling grooves 150 may be provided in plural. Additionally, one connection busbar member cooling groove 150 may face one connection busbar member 120c. Accordingly, cooling of the connection busbar member 120c may also be performed.

Additionally, as an example, the connection busbar member cooling groove 150 facing one connection busbar member 120c may be interposed between a pair of electrode leads 111. That is, the connection busbar member cooling groove 150 may face a region existing between the pair of electrode leads 111 in the connection busbar member 120c. Accordingly, a region having a relatively large amount of heat generation may be cooled in the connection busbar member 120c.

Additionally, as an example, the connection busbar member cooling groove 150 may face the centroid of the connection busbar member 120c. The region may be a region having a relatively large amount of heat generation in the connection busbar member 120c, and accordingly, the connection busbar member 120c may be effectively cooled. Accordingly, the busbar frame 130 may be prevented from being damaged by a region having a large amount of heat generation in the connection busbar member 120c.

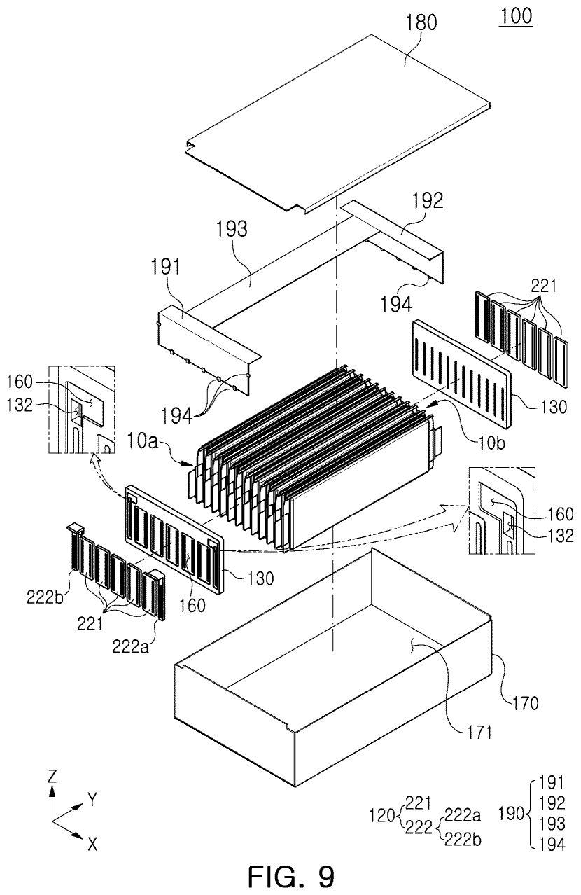

FIG. 9 is a schematic exploded perspective view of a battery apparatus 100 according to another embodiment of the present disclosure. As shown in FIG. 9, in an embodiment of the present disclosure, a busbar frame 130 may include a notch 160 into which a busbar member 120 may be inserted. In the X-Z plane, an outer line of the notch 160 may correspond to an outer line of the busbar member 120. In this case, a cooling groove 132 may be disposed in the notch 160.

The busbar member 120 may include a first busbar member 222a connected to the battery cell 110 disposed on an outermost side of one side, among a plurality of battery cells 110, a second busbar member 222b connected to a battery cell 110 disposed on an outermost side on the other side, and a plurality of third busbar members 221 connected to a plurality of battery cells 110 interposed between the plurality of outermost battery cells 110.

In this case, the notch 160 may be provided in a region facing the first busbar member 222a, the second busbar member 222b and the third busbar member 221 in the busbar frame 130. Here, the cooling grooves 132 may be provided in plural, and one cooling groove 132 may face the first busbar member 222a, and another cooling groove 132 may face the second busbar member 222b.

The busbar frames 130 may be respectively disposed on one side 10a and the other side 10b of the plurality of battery cells 110. The first busbar member 222a, the second busbar member 222b and the third busbar member 221 may be fixed to the busbar frame 130 disposed on one side 10a of the battery cell 110, and the third busbar member 221 may be fixed to the busbar frame 130 disposed on the other side 10b of the battery cell 110. In this case, the busbar frame 130 disposed on the other side 10b of the battery cell 110 may be provided with a notch 160 having a shape corresponding to the third busbar member 221.

In an embodiment, the battery apparatus 100 may further include a sensing unit 190. The sensing unit 190 may include a first substrate 191 connected to the busbar member 120 disposed on one side 10a of the battery cell 110, a second substrate 192 connected to the busbar member 120 disposed on the other side 10b of the battery cell 110, and a connecting board 193 connecting the first substrate 191 and the second substrate 192.

The first substrate 191 and the second substrate 192 may be printed circuit boards (PCB). Each of the first substrate 191 and the second substrate 192 may include a plurality of connection terminals 194. The plurality of connection terminals 194 may be connected to the busbar member 120. Accordingly, voltage information of the battery cell 110 may be sensed.

The connection board 193 may be a flexible printed circuit board (FPCB).

Additionally, in an embodiment, the plurality of battery cells 110, the sensing unit 190, the busbar frame 130 and the busbar member 120 may be accommodated in a case 170 including an accommodation unit 171. The case 170 may be provided with a material having a certain level of rigidity or higher.

A cover member 180 may be provided in an upper portion of the battery cell 110 in the height direction (Z-direction) of the case 170. The cover member 180 may cover a plurality of battery cells 110, a sensing unit 190, a busbar frame 130 and a busbar member 120. The cover member 180 may be fixed to an upper portion of the case 170.

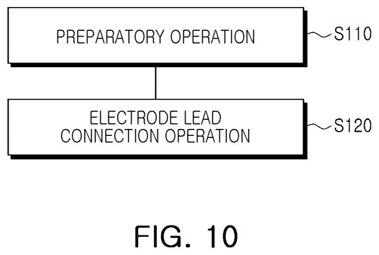

On the other hand, as another aspect, the present disclosure provides a method for manufacturing a battery apparatus 100 to manufacture a battery apparatus including a plurality of battery cells 110 respectively including a plurality of electrode leads 111, a busbar member 120 connected to the plurality of electrode leads 111, and a busbar frame 130 supporting the busbar member 120. FIG. 10 schematically illustrates a method for manufacturing a battery apparatus 100 according to an embodiment of the present disclosure. The busbar member 120 may be provided in plural. A plurality of busbar members 120 may be connected to a plurality of electrode leads 111.

As shown in FIG. 2 and FIG. 10, a method for manufacturing a battery apparatus 100 according to an embodiment of the present disclosure may include a preparatory operation (S110) of preparing a busbar frame 130 in which at least one cooling groove 132 for cooling the busbar member 120 is formed on a support surface 131 supporting the busbar member 120, and an electrode lead connection operation (S120) of connecting the electrode lead 111 of the battery cell 110 to the busbar member 120.

The cooling groove 132 may be formed in the busbar frame 130 by laser processing, or the like. However, the method of forming the cooling groove 132 is not necessarily limited by the present disclosure.

Additionally, a plurality of cooling grooves 132 may be formed in the busbar frame 130.

Additionally, in the busbar frame 130, a cooling groove 132 may be formed in a region in which the busbar frame 130 faces the first outermost busbar member 120a and the second outermost busbar member 120b. Accordingly, the busbar member 120 may be cooled in a region in which the busbar member 120 has a high heat generation amount, and damage to the busbar frame 130 may be prevented.

In the electrode lead connection operation (S120), the electrode lead 111 may be drawn out of the busbar member 120 by penetrating through the busbar frame 130 and the busbar member 120, and may then be bent. In the electrode lead connection operation (S120), the electrode lead 111 may be welded to the busbar member 120.

In the electrode lead connection operation (S120), a plurality of electrode leads 111 may be connected to multiple busbar members 120.

The above-described content is merely an example of applying the principle of the present disclosure, and other components may be further included or substituted and applied without departing from the scope of the present disclosure. Additionally, the above-described embodiments may be applied alone or in combination of a plurality of embodiments.

What is claimed is:

1. A battery apparatus, comprising:
a plurality of battery cells respectively including a plurality of electrode leads;
a busbar member connected to the plurality of electrode leads; and
a busbar frame supporting the busbar member,
wherein the busbar frame includes a support surface facing the busbar member, and
the support surface includes at least one cooling groove.

2. The battery apparatus of claim 1, wherein the plurality of battery cells include:
an external material accommodating an electrode assembly; and
the plurality of electrode leads connected to the electrode assembly and drawn out to the outside of the external material,
wherein the support surface and the at least one cooling groove do not face the external material.

3. The battery apparatus of claim 1, wherein the at least one cooling groove is disposed above the plurality of electrode leads in a height direction of the battery cell, in a width direction cross-section of the battery cell.

4. The battery apparatus of claim 1, further comprising:
an insulating member disposed in the at least one cooling groove.

5. The battery apparatus of claim 1, wherein the at least one cooling groove has an outer line having a polygonal shape in a thickness direction cross-section of the battery cell.

6. The battery apparatus of claim 1, wherein the at least one cooling groove has an outer line that includes a curve in a thickness direction cross-section of the battery cell.

7. The battery apparatus of claim 1, wherein the busbar frame further includes at least one exhaust groove connected to at least one cooling groove and extending toward a region not facing the busbar member.

8. The battery apparatus of claim 7, wherein the at least one exhaust groove includes:
a first exhaust groove connected to one side of the at least one cooling groove and extending in a direction, parallel to a thickness direction of the battery cell; and
a second exhaust groove connected to the other side of the at least one cooling groove and extending in a direction, intersecting the first exhaust groove.

9. The battery apparatus of claim 8, wherein at least one of the first exhaust groove and the second exhaust groove extends to an edge of the busbar frame.

10. The battery apparatus of claim 1, wherein the busbar member includes:
a plurality of connection busbar members disposed on one side and the other side of the battery cell, and connecting a pair of electrode leads adjacent to each other;
a first outermost busbar member disposed on one side or the other side of the battery cell, and connected to a first outermost battery cell disposed on an outermost side of one side, among the plurality of battery cells; and
a second outermost busbar member disposed on one side or the other side of the battery cell, and connected to a second outermost battery cell disposed on an outermost side of the other side, among the plurality of battery cells.

11. The battery apparatus of claim 10, wherein the at least one cooling groove includes a plurality of cooling grooves, and
the plurality of cooling grooves face the first outermost busbar member and the second outermost busbar member.

12. The battery apparatus of claim 11, wherein in a height direction of the battery cell, a height of the first outermost busbar member and the second outermost busbar member is higher than a height of at least one connection busbar member, among the plurality of connection busbar members.

13. The battery apparatus of claim 12, wherein the at least one cooling groove includes a region exceeding a height of the at least one connection busbar member in a height direction of the battery cell.

14. The battery apparatus of claim 10, wherein the at least one cooling groove includes a plurality of cooling grooves,
wherein the plurality of cooling grooves face the plurality of connection busbar members.

15. A method for manufacturing a battery apparatus comprising a plurality of battery cells respectively including a plurality of electrode leads, a busbar member connected to the plurality of electrode leads, and a busbar frame supporting the busbar member, comprising:
a preparatory operation of preparing the busbar frame having at least one cooling groove formed on a support surface supporting the busbar member; and
an electrode lead connection operation of connecting the plurality of electrode leads to the busbar member.
